(19) United States
(12) Patent Application Publication
(10) Pub. No.: US 2010/0144442 A1
(43) Pub. Date: Jun. 10, 2010

(54) INTEGRATED ENTERTAINMENT ARRANGEMENT AND METHODS THEREOF

(76) Inventor: Anthony Yanow, Los Angeles, CA (US)

Correspondence Address: IPSG, P.C., P.O. BOX 700640, SAN JOSE, CA, 95170, US

(21) Appl. No.: 12/328,562

(22) Filed: Dec. 4, 2008

(51) Int. Cl. A63F 13/00; A63J 5/00

(52) U.S. Cl. 463/42; 472/57; 463/1

(57) ABSTRACT

An arrangement for providing an immersive experience for a participant is provided. The arrangement includes an atmosphere component, wherein the atmosphere component includes one or more enhancements designed to create an alternate reality for the participant. The arrangement also includes a personal accoutrements component, wherein the person accoutrements component includes at least an arrangement for enabling the participant to become a persona that is an integrated member of the alternate reality. The arrangement further includes an activity component, wherein the activity component includes a plurality of events that support a unified entertainment theme that further enhances the participant's experience in the alternate reality.

### BACKGROUND OF THE INVENTION

The leisure activity industry is a multibillion industry. Entertainment centers have capitalized on the desire for leisure activities by providing people with a fairly safe and secured environment in which the need for leisure activities may be met. As the term is employed herein, an entertainment center may refer to large theme parks, such as Disneyland™, or smaller establishments, such as Chuck E Cheese™.

In general, an entertainment center is a place in which a variety of leisure activities may be made available. The type of activities available may vary depending upon the type of entertainment centers. In an example, at Shlitterbahn™, a guest may participate in a variety of water activities, such as sliding down a giant water slide, standing under a giant water bucket tubing down a gentle river, and the like. However, at a smaller establishment, such as Chuck E Cheese™, a guest may enjoy arcade games, simulation games, and other electronic games.

Although entertainment centers provide centralized locations at which a variety of activities can be enjoyed, entertainment centers tend to be viewed as “spectator” activities. In an example, at Disneyland™, multiple fantasy worlds are created in which rides and shows are provided as different options the guests may select to temporarily join the fantasy worlds. Despite the existence of fantasy worlds, most entertainment centers employed the fantasy worlds as backdrops for the activities that are being provided. The entertainment centers usually do not integrate the activities into the fantasy worlds.

Even if an activity may provide the guests with an opportunity to become integrated with the fantasy, the integration is usually for a very short period of time since most activities usually last about one to five minutes. In addition, as the guests move between activities, the fantasy is usually not maintained. For example, Charlie may have been a flyer pilot in the last activity; however, as Charlie is moving to the next activity, a boat ride, Charlie has emerged from the last fantasy and has become Charlie again until he takes part in the next activity. As a result, Charlie, as a guest, is constantly reminded that he is only a “spectator” of the fantasy worlds.

### SUMMARY OF INVENTION

The invention relates, in an embodiment, to an arrangement for providing an immersive experience for a participant. The arrangement includes an atmosphere component, wherein the atmosphere component includes one or more enhancements designed to create an alternate reality for the participant. The arrangement also includes a personal accoutrements component, wherein the person accoutrements component includes at least an arrangement for enabling the participant to become a persona that is an integrated member of the alternate reality. The arrangement further includes an activity component, wherein the activity component includes a plurality of events that support a unified entertainment theme that further enhances the participant's experience in the alternate reality.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in an embodiment of the invention, an abstract diagram of an integrated entertainment arrangement.

FIG. 2 shows, in an embodiment of the invention, a simple flow chart illustrating an overall method for implementing the integrated entertainment arrangement.

FIG. 3 shows, in an embodiment of the invention, a simple flow chart illustrating steps for planning a special event.

FIG. 4 shows, in an embodiment of the invention, a simple flow chart illustrating steps for setting up an invitation-only online community.

FIG. 5 shows, in an embodiment of the invention, a simple flow chart illustrating steps for joining an invitation-only online community.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that include a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Most people have at least one favorite pastime. The individuals usually spend their “free time” indulging in their favorite pastimes. In addition, many people fantasize about the ability to “live out” their favorite pastime in their everyday life. In an example, a person who enjoys car racing dreams of living the life of a race car driver. Although the prior art entertainment centers provide fantasy worlds, the entertainment centers rarely allow the guests to become an integral part of the fantasy worlds. As a result, most entertainment centers fail to satisfy the needs of the individuals who want to be fully immersed in their favorite pastime.

Embodiments of the invention pertain to arrangements and techniques for providing an immersive experience relating to a unified entertainment theme. The immersive experience includes one or more of providing an online and/or offline atmosphere promoting the unified entertainment theme, online and/or offline personal accoutrements enhancing the unified entertainment theme, and online and/or offline activities enacting at least aspects of the unified entertainment theme. Furthermore, embodiments of the invention provide arrangements and techniques for maintaining continuity between the online immersive experience and the offline immersive experience, thereby allowing a participant to remain entertained irrespective whether the participation is online or offline or both at different times.

In an embodiment of the invention, an offline experience may be created to foster the participant's dreams of becoming an integral part of the fantasy worlds created by the integrated entertainment centers. The offline experience may be provided through integrated entertainment centers that create environments that encourage guests to become active participants within alternate realities. The offline experience may be created through atmosphere, personal accoutrements, and activities.

In an embodiment of the invention, an offline atmosphere may be created in which reality may be suspended while the participant is within the integrated entertainment center. In an example, the integrated entertainment center may be designed and/or decorated in a manner that supports the new reality. Consider the situation wherein, for example, the integrated entertainment center is a car racing entertainment center for youth. The integrated entertainment center may be visually designed with race cars, race tracks, pit stops, and the like. Also, the atmosphere may be further enhanced with sounds and noises typically found at a race car event. As a result, the different sensory characteristics typically associated with a specific reality, such as a race car event, inundate a participant's senses thereby creating an alternate reality that the participant can easily become immerse in.

In another embodiment of the invention, offline personal accoutrements may be employed to enhance the unified entertainment theme. In an example, as part of the reality suspension, role playing may be provided as an offline personal accoutrement. For example, a participant may be provided with costumes thereby enabling the participant to become an integral member (such as a race care driver or a pit crew member) of the new reality, in an embodiment. In another example, the participant may become an alternate reality member by playacting, such as exhibiting behaviors typically characterized of people at a race car event, for example. In yet another example, code of conduct may be established thereby establishing rules and boundaries for the participants within the alternate reality. As can be appreciated by the foregoing, other rules and guidelines may be established to make the alternate reality more realistic.

In yet another embodiment of the invention, offline activities may be provided at the integrated entertainment center that further encourage the participants to suspend reality. In an example, at a car racing entertainment center, activities may include building race car tracks, designing race cars, participating in races, and the like. The activities may be designed as either hand-on activities or virtual activities, in an embodiment.

Within the integrated entertainment center, the activities, role-playing and the atmosphere all support the unified entertainment theme. In other words, as the participant moves between activities, the participant does not move from an active participant role to that of a spectator guest. Instead, the alternate reality is maintained until the participant is ready to “check out” for the day.

In an embodiment of the invention, an online experience may be created to enable the participants to continue the alternate reality experience offsite. In an example, a web-based car racing environment may be provided for participants who enjoy the different aspects of car racing. Similar to the offline experience, the online experience may be created also through atmosphere, personal accoutrements, and activities.

In an embodiment of the invention, an online atmosphere may be designed to create a virtual alternate reality for participant. In an example, the web-based environment may include elements commonly found at a race car event, such as race cars, excited audience, race tracks, pit crews, and the like. Incorporated into the web-based environment could also be sounds and noised commonly heard at a race car event. In another example, the web-based environment may be a creation of a virtual race world in which the participant may be an active member of the virtual race world.

In another embodiment of the invention, the online experience may include online personal accoutrements. In an example, participants may role play while they are members of the online virtual alternate. reality. For example, a participant may create an online persona that may represent a character commonly seen at a race car track, such as a race car driver or a pit crew member. To further enhance the virtual alternate reality, the online persona may participate in community interaction with other participants' online personas, thereby allowing the participant to develop relationships with other participants who have common interests. In an example, a group of boys who go to school together may become friends by sharing their interests in similar hobby not only offline at the integrated entertainment center but also online through community interaction at the web-based environment.

In an embodiment of the invention, the online experience may also include web-based activities. In an example, different race activities, such as racing around the track, car building, track building, and the like may be enjoyed by the online persona of the participant. Participating in the activities may allow the participant to earn points. The points may be employed as a method for improving the participant's standing within the virtual alternate reality. Additionally or alternatively, the points may also be applied toward prizes.

Embodiments of the invention enable the alternate reality to be maintained by creating continuity between the online and the offline immersive experience. In an example, a participant with an online persona may choose to maintain his/her online persona while at the physical location of the integrated entertainment center. In another example, the participant's current online standing may be respected offline by creating an offline experience that allows the participant to enjoy privileges based on higher online persona's standing. In yet another example, activities played at the physical location may be saved as part of the online profile of the participant, thereby enabling the participant to enhance his online persona's standing while playing games at the physical location.

In an embodiment, activities may be provided either offline and/or online that enable the participant to integrate the offline/online alternate reality. In an example, the online activities may represent web-based representation of activities that the participant may have enjoyed at the physical location. In an example, building of race car tracks may be duplicated through a virtual race car track building activities. In another example, the web-based activities may be utilized to enhance the activities a participant may enjoy at a physical location. For example, the participant may create race car track blueprints prior to going to the physical location. Using the blueprints, the participant may create the physical representation at the physical location of the integrated entertainment center.

In yet another example, a participant's score achieved through activities, may be redeemed for either online or offline prizes. In yet another example, the participant's score may be employed to qualify for competitions that may be held online and/or offline at the integrated entertainment centers.

In an embodiment, arrangements for special events (birthday party, play-date, and the like) may be provided either offline/online or both. To arrange a special event, arrangement may be made offline with one of the staff member of the integrated entertainment center, online through the guided special event menu, or through a combination of both offline staff help and online guide. In an example, the special event may be arranged in person, by telephone and/or online, in an embodiment. If the special event is arranged in person, the arranger may go to the integrated entertainment center and talk to a staff member specializing in special events. If the special event is arranged via telephone, the arranger may pick up a special event package that provides the details the arranger may need to plan for the event. Once the arranger has determined the details of the special event, the arranger may call the integrated entertainment center to finalize the arrangement.

If the special event is arranged online, the arranger may log onto the website associated with the integrated entertainment center. Online, the arranger may be provided with package selections from which the arranger may chose from, in an embodiment. In another embodiment, the arranger may be guided through the planning process as the arranger creates the desired special event package. In an example, the completed special event package may include a party at the physical location, an invitation-only online community established for the invited guests, and invitations managed by the integrated entertainment center staff members.

As can be appreciated from the foregoing, special events may be arranged through a combination of both online and offline help. In an example, the arranger may have used the online guided menu to initially setup a special event. However, the arranger may finalize the arrangement for the special event by talking with a staff member at the integrated entertainment center.

As can be appreciated from the foregoing, a unified entertainment theme may be provided by providing arrangements and methods for creating an online/offline immersive experience. The offline experience encourages guests to live out their dreams as the guests become active participants of fantasy worlds created by the integrated entertainment arrangement. The unified entertainment theme is further enhanced by the online experience that fosters the new reality through web-based alternate reality. In addition, the integration between the online/offline experiences allows the participants to continue their immersive experience as the participants move between the offline experience and the online experience.

The features and advantages of the present invention may be better understood with reference to the figures and discussions that follow.

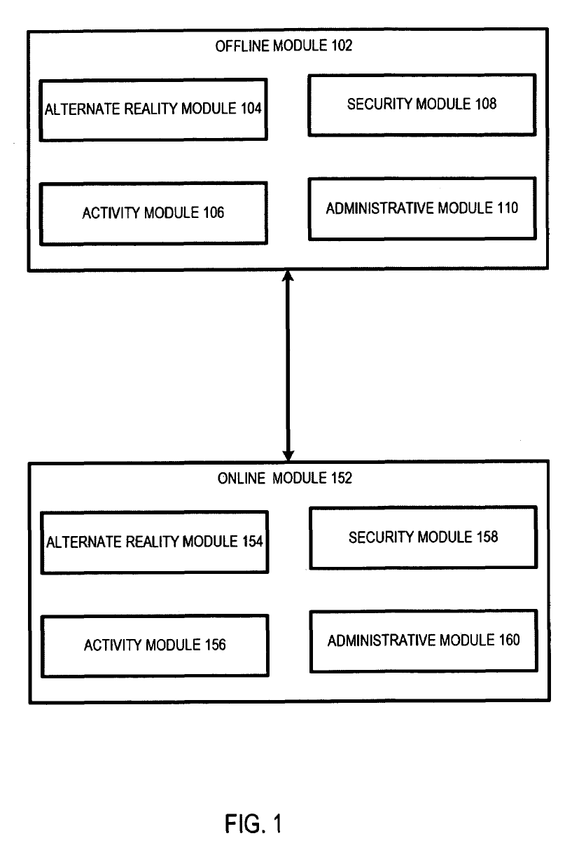

FIG. 1 shows, in an embodiment of the invention, an abstract diagram of an integrated entertainment arrangement that provides for a unified immersive theme. The integrated entertainment arrangement may include an offline module 102 and an online module 152. Offline module 102 may include a physical location (such as a brick-and-mortar building, a park arrangement, and the like) for the integrated entertainment center. Online module 152 may include a web presence (such as a web site). Offline module 102 provides a participant a physical location for indulging in his favorite pastime while the online module 152 enables the participant to satisfy his needs to partake in his favorite hobby in a virtual environment when the participant is unable to visit the physical location of the integrated entertainment center.

In an embodiment, offline module 102 may include an alternate reality module 104. Alternate reality module 104 is configured at least to create an offline atmosphere that allows a participant to become immerse in his favorite pastime. In an example, the physical location of the integrated entertainment center may be designed in a manner that transforms the participant's reality when the participant enters the physical location of the integrated entertainment center. For example, at a car racing entertainment center, the physical location may include race tracks, race cars, sounds and noises typically found at a car race, and the like.

In an embodiment, alternate reality module 104 may also provide offline personal accoutrements to enhance the unified entertainment theme. In an example, costumes may be provided for the participant to wear. For example, when a child walks into a car racing entertainment center, the child is assigned a locker in which he may store away his “real life” while he is transformed into a race car driver, for example. By altering the participant's physical appearance, a more immersive environment is created not only for the participant but also for the other participants.

In an embodiment, offline module 102 may also include an activity module 106. The activities that may be provided are aimed at promoting the alternate reality of the integrated entertainment center. In an example, a child at a car racing entertainment center may create new race tracks, design new cars, and the like. In an embodiment the activities may be either hand-on activities or virtual activities.

In an embodiment, offline module 102 may include a security module 108. As can be appreciated from the foregoing, the alternate reality may only be maintained if the participant feel secured in his surroundings. In an embodiment, the offline experience includes an integrated entertainment center that provides a secured environment in which the participant may indulge in his hobby. Those skilled in the arts are aware that there is a plurality of common security measures (such as security cameras) that may be employed to provide physical protection for the people within the premise. In an example, at the physical location, security measures are implemented to check for firearms and other weapons.

For integrated entertainment centers that cater to children, a check-in/check-out system may be established to ensure the safety of a child. In an example, a matching identification method may be provided to prevent a child from being taken off the premise without going through the proper security procedure. For example, the child participant and his grow-up are assigned unique identification (such as stamping a unique mark on both the child and his grown-up) that corresponds to one another. Thus, regardless if the grown-up stays to monitor the child participant or the child participant is dropped off (e.g., day-care center), the unique identification, for example, prevents the child from being removed from the premise without being accompanied by his grown-up. As can be appreciated from the foregoing, the type of security measures that may be implemented may vary depending upon the need of each integrated entertainment center.

In an embodiment, offline module 102 may also include an administrative module 110. Administrative module 110 may be configured to handle administrative issues, such as membership. In an embodiment, the integrated entertainment center may include different membership levels. In an example, a daily membership may be given to guests who are infrequent visitors to the integrated entertainment center. In another example, frequent guests may opt for monthly or even annual membership. The level of membership may provide special treatment for those with higher level of membership. In an example, an annual membership may allow a participant to invite a friend.

In an embodiment, administrative module 110 may also be configured for handling of special events (e.g., birthday). The special event may be arranged in person or by telephone. A staff member is available to assist the arranger in planning for the special event.

As can be appreciated from the foregoing, a participant's favorite pastime is usually an integrated part of the participant's life. To enable the participant to continue indulging in his favorite pastime outside of the physical location of the integrated entertainment center, a web-based environment is provided by online module 152. By creating an online outlet for the participant the integrated entertainment center is able to build brand loyalty without having to perform aggressive advertisement.

Similar to offline module 102, online module 152 may include an alternate reality module 154, which is configured at least to create an online atmosphere that allows the participant to enjoy in a virtual environment a similar alternate reality as experienced at the physical location. In an example, a website catering to race car enthusiasts may have images, design elements, noises and sounds that may typically represent a race care track event.

In an embodiment, the online module 152 may also provide for online personal accoutrements to enhance the unified entertainment theme. In an example, the participant may become integrated into the virtual alternate reality by creating an online persona that may visually looks like an individual that may typically be seen at a race car track event. For example, the participant may create a race car driver as an online persona.

In another embodiment, alternate reality module 154 may create virtual community in which the online persona of the participant may interact with other online personas. In an embodiment, the virtual community is a public community that is open to the general public. In another embodiment, an invitation-only online community may be created in which only participants invited may join. The invitation-only online community creates a safe and secured environment in which online predators are “locked out”. If the web-based environment is catered to children, the invitation-only online community is created by a grow-up and invitation is sent to a corresponding contact address of the grow-up associated with the child being invited. By controlling the invitation, concern parents may have the assurance that the children are only interacting with other participants that have been invited by the grow-up.

In an embodiment, online module 152 may include an activity module 156. The activities provided by activity module 156 may be virtual representations of activities that the participant may have participated in at the physical location. In an example, building a car may be duplicated by a virtual car building/designing activity. In another embodiment, activity module 156 may include virtual activities that may be played both at the physical locations and offsite.

Web-based activities (either played online or at the physical location) may include a scoring arrangement. The score may be redeemed for prizes, such as online prizes or physical prizes. In an example, online prizes may include virtual enhancement that a participant may buy with the points he earned to provide his online persona with online comforts (e.g., house, different clothing, different physical traits, etc). In another example, physical prizes may be toys that may be redeemed through the integrated entertainment centers. In an embodiment, to encourage the participants to visit the physical location, the physical prizes may only be redeemed in person at the physical location.

In an embodiment, the score of a participant may qualify the participant for special competitions. Special status may be given to those participants who qualified for a special competition and/or wining a special competition. In an example, special status may include online commendations. In another example, special status may mean the name of the online persona being posted offline at the integrated entertainment center.

In an embodiment, online module 152 may include a security module 158. In today online environment, a variety of online security method may be employed to provide a safe and secure environment. In an example, a participant may be required to provide authentication data before joining an online community. For web-based environment catering to children, a child account may be created with grow-up contact information provided. To prevent inappropriate comments and/or to minimize online predators, moderators may be utilized to monitor the web-based environment. In an example, the participant may be forbidden from requesting and/or providing personal information that does not pertain to the alternate reality world and/or online persona.

As an additional security measure, a concern parent may create an invitation-only online community. The invitation-only online community is a community that is created through invitation only. This type of community prevents uninvited participants from joining the invitation-only online community. Since the invitation-only online community is by invitation, the invitation-only online community provides an additional security measure that provides assurance to parents that are leery of online communities that are opened to the general public.

In an embodiment, online module 152 may include an administrative module 160, which may be responsible for handling memberships. In an embodiment, membership may include paid and unpaid memberships. Although both paid and unpaid memberships may have access to the public community and activities provided by the website, paid membership may provide the participant with more-challenging activities, more prize selections, and the like. In an embodiment, online membership may be coupled with offline membership, thereby enabling the participant to enjoy membership privileges at both the physical location and the web-based environment.

In an embodiment, administrative module 160 may also include an online avenue for an arranger to plan for a special event. Online, the arranger may plan the special event by answering a series of questions, in an embodiment. Although an online arrangement may be performed without a staff member's help, staff member may access the arranger's account to assist the arranger if the arranger has questions about the online arrangement.

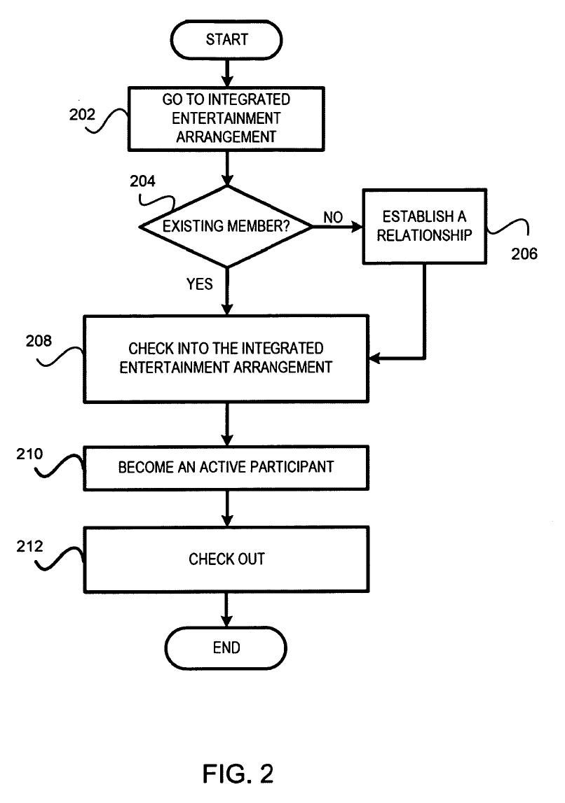

FIG. 2 shows, in an embodiment of the invention, a simple flow chart illustrating an overall method for implementing the integrated entertainment arrangement.

At a first step 202, a guest goes to the integrated entertainment arrangement. Consider the situation wherein, for example, a child is going to a car racing entertainment center.

At a next step 204, a relationship is determined. In an example, the guest may be a member of the car racing entertainment center and has already paid the membership fee. In another example, the guest may not be a member and may only be going to the car racing entertainment center for the day.

If the guest does not have a relationship with the integrated entertainment center, the participant establishes a relationship with the entertainment center at a next step 206. In the above example, if the guest is only spending a day at the car racing entertainment center, the guest establishes a relationship with the car racing entertainment center by paying a daily rate.

Once a relationship has been established, the guest may check into the integrated entertainment arrangement, at a next step 208. In an example, a special identification mark may be stamped onto the hands of the child and his grow-up. The special identification mark is unique and helps prevent a child from being removed from the premise without his grow-up.

At a next step 210, the guest becomes an active participant. In an example, the guest may “get into character” by changing into a costume that allows the guest to become an active participant of the alternate reality within the integrated entertainment center. Since the integrated entertainment center provides an alternate reality, the surrounding and the atmosphere allow the participant to be immersed in the alternate reality. Since the integrated entertainment center is created to attract people of similar interest, participants may form new relationship through share interest. The new relationship may be developed through interaction with other participants. In addition, the participants may take part in a plurality of competitive and team-building activities.

At a next step 212, a participant checks out of the integrated entertainment arrangement. As a process of checking out, the participant may transform back into his real self by changing out of his costume. For integrated entertainment center that caters to children, a child is prevented from being checked out without his grow-up. As aforementioned, a matching method may be employed to provide a secure method for checking out a child.

As previously discussed, the alternate reality created and enjoyed by the participant at the physical location of the integrated entertainment center may also be enjoyed online. FIG. 2 may also be employed to describe the method for participating in a virtual alternate reality.

At step 202, the guest goes to the website of the integrated entertainment center.

At step 204, a determination is made about the relationship of the guest with the website.

If the guest is not a member, the guest registers with the website, at step 206. In an embodiment, if the guest is a child, a grow-up's contact information may be required to be associated with the child to provide a source of contact for the website to communicate with a guardian of the child.

Once a relationship has been established, at step 208, the guest may log onto the system. The log-in process may include an authentication process.

At step 210, the guest is logged onto the system and may interact with other participants and/or play web-based activities.

When the participant has finished playing, the participant may log off the website at step 212.

As can be appreciated from FIG. 2, the steps described above may be employed to create an integrated entertainment arrangement at a physical location, online, or a combination of both. In both the online and offline environments, the participant is able to indulge in his fantasy. By creating an alternate reality that may be experience either online or offline, a unified entertainment theme is created that allows the participant to seamlessly move between the two environments.

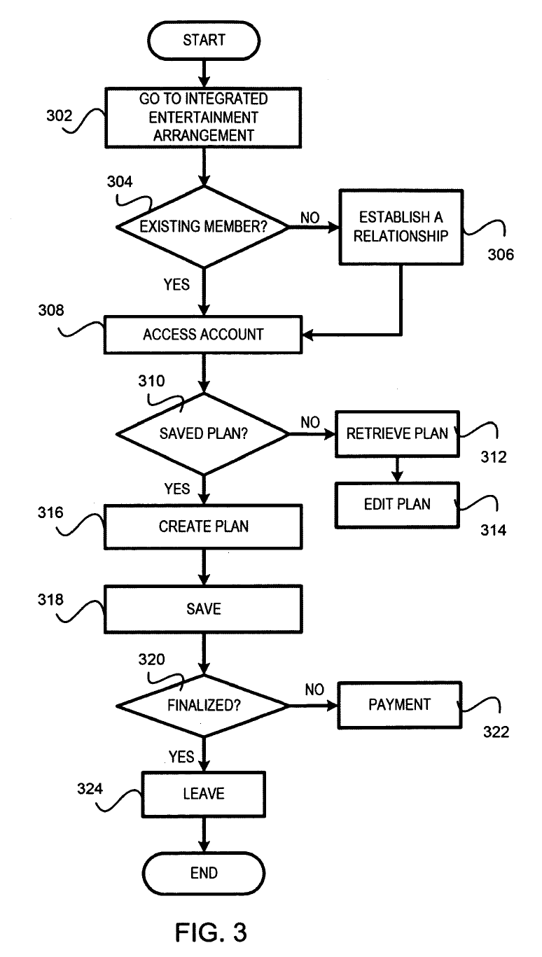

FIG. 3 shows, in an embodiment of the invention, a simple flow chart illustrating steps for planning a special event. Consider the situation wherein, for example, a birthday party is being planned at an integrated entertainment center.

At a first step 302, an arranger (i.e., person arranging the special event) goes to the integrated entertainment arrangement. In an embodiment, the arrangement may be performed in-person, via telephone, and/or online. If the arrangement is performed in-person, the arranger may go to the physical location of the integrated entertainment center to talk to a special event staff member. If the arrangement is done via telephone, the arranger may work with a special event staff member through the telephone. If the arrangement is performed online, the arranger may go to the website associated with the integrated entertainment center.

At a next step 304, a determination is made about the relationship of the arranger to the integrated entertainment center.

If the arranger does not have a relationship (e.g., account) with the integrated entertainment center, at a next step 306, an account may be set up.

Once a relationship has been established, at a next step 308, the account may be accessed. To access the account, the special event staff member may pull up the arranger's account, in an example. If the arrangement is being made online, the arranger may log onto the website.

At a next step 310, a determination is made if the plan for the special event has been previously saved.

If the plan has been previously saved, at a next step 312, the plan is retrieved from the database. Those familiar with party planning is aware that different criteria may be considered in planning a special event. The criteria may include, but are not limited to, the age of the participants, the number of participants, the size of the premise, the type of activities, the availability of foods and drinks, the handling of invitations and reminders, and the like.

At a next step 314, the arranger may make changes to the plan.

However, if the plan has not been previously saved, at a next step 316, details about the special event are provided. In an example, if the arranger is working with a special event staff members, the staff member may assist the arranger in the planning by asking a series of questions. In another example, if the arranger is making the arrangement online, a series of questions may guide the arranger in planning the special event.

Throughout the process, the plan may be saved, at a next step 318. By saving the information, the arranger may access the plan al a future date.

At a next step 320, a determination is made on whether or not the plan has been finalized.

If the plan has been finalized, at a next step 322, payment may be made before the arranger leaves (step 324).

However, if the plan has not been finalized, at step 324, the arranger may leave and begin the process again when the arranger needs to edit the plan or is ready to finalize the plan. As can be appreciated from the foregoing, since the arrangement is saved, the arranger may access the saved plan for the special event at a later date while online and/or while working with a staff member.

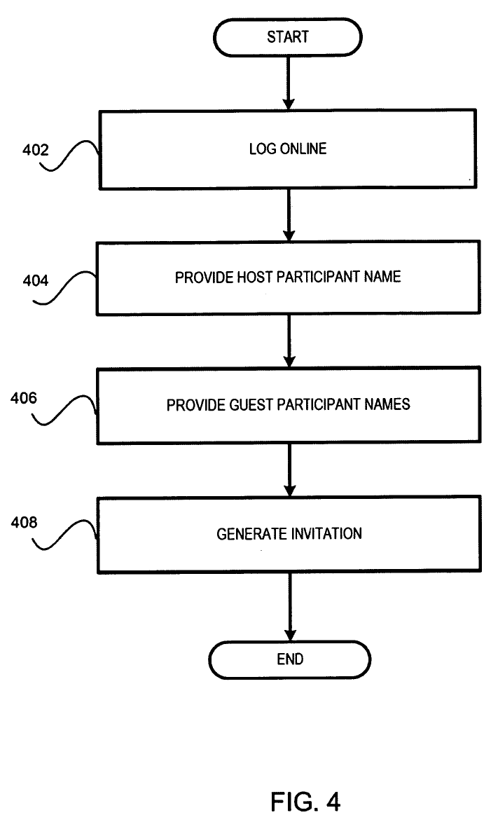

FIG. 4 shows, in an embodiment of the invention, a simple flow chart illustrating steps for setting up an invitation-only online community. Consider the situation wherein, for example, a parent of a child wants to allow the child to participant in the website of the integrated entertainment center but is concerned about the behavior of the other participants online. To address the parent's concerns, an invitation-only online community may be created in which participants may only join via invitation.

At a first step 402, an arranger may log onto the website of the integrated entertainment center.

At a next step 404, name of the host participant is provided. In an example, the parent may enter in her child name. In an embodiment, the name of the host participant may be automatically provided if the arranger's account is associated with the host participant.

At a next step 406, the guest participant contact information is provided. In an example, the name of the child and the contact information (such as an email address) of his grow-up is provided.

At a next step 408, upon receiving the data, the system generates invitations that are sent to the guest participant.

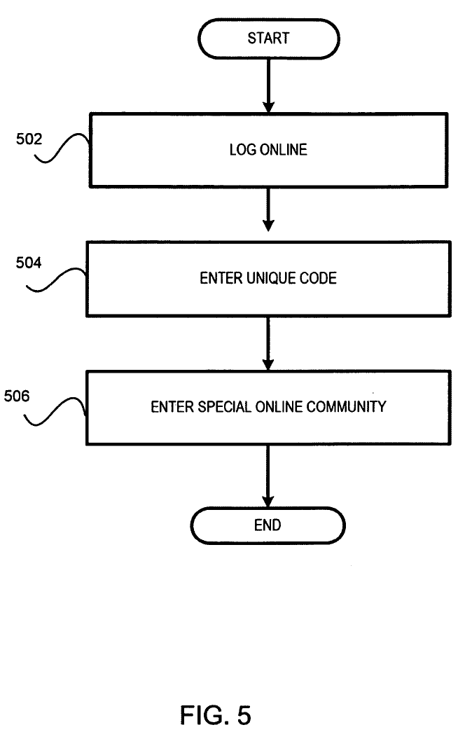

FIG. 5 shows, in an embodiment of the invention, a simple flow chart illustrating steps for joining an invitation-only online community. Consider the situation wherein, for example, a child has received an invitation to join an invitation-only online community. As aforementioned, the invitation-only online community may be established due to a special event (such as birthday) or as a security measure (such as by a concerned parent).

At a first step 502, a participant logs onto the website of the integrated entertainment center.

At a next step 504, the participant enters a unique code associated with the invitation.

At a next step 506, the participant is allowed access into the invitation-only online community. Within the invitation-only online community, the participant may interact with other members of the community. In addition, the participant may also take part in the different activities that may be available. In an embodiment, activities with two or more players may be limited to members only. In other words, the participant may not play with an outside member who is not a member of the invitation-only online community. In an embodiment, if the invitation-only online community has been created for a special event, such as a birthday, details about the upcoming event may be provided within the invitation-only online community.

As can be appreciated from FIGS. 4 and 5, the invitation-only online community provides an additional layer of security by providing the host participant with the ability to control the participants that may be invited to his special online community. In other words, with an invitation-only online community; the participants within the community are protected from potential online predators. Besides providing an additional security measure, the invitation-only online community also encourages deeper relationships to be developed between participants that share a common interest.

As can be appreciated from the foregoing, the integrated entertainment arrangement provides an integrated entertainment center that allows its members to indulge in their favorite pastime. In the prior art, the entertainment centers are usually catered to a wider audience. As a result, the activities are usually not tailored to a specific pastime. In an attempt to cater to the general mass, a variety of different activities may have to be provided. Thus, a participant may not always enjoy every aspect of a prior art entertainment center. In an example, boys interested in racing car, may only find a select few activities at a typical entertainment centers that may keep their interest and may avoid most of the princess activities that may be designed for a female audience.

In addition, the guests at prior art entertainment centers may include individuals with eclectic interests. As a result, the participants at the prior art entertainment centers may not always have common taste. Unlike the prior art entertainment centers, the integrated entertainment center caters to an audience who share a common interest. As a result, the integrated entertainment center not only provides a place for the participant to indulge in his favorite pastime but also provides a safe and secured environment for the participant to meet new people with common interest.

As can be appreciated from the foregoing, by coupling a web-based environment with a physical location, the relationship between the participant and the integrated entertainment center may be developed and solidify. The web-based environment not only provides a virtual environment for the participant to indulge in his favorite pastime but also provide an avenue for the integrated entertainment center to become integrated into the everyday life of the participant. As a result, the integrated entertainment center may effectively perform branding without active marketing. In addition, by becoming an integral part of the participant's life, the integrated entertainment center may become the choice location when the participant wants to spend time at a physical location.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. An arrangement for providing an immersive experience for a participant, comprising:
an atmosphere component, wherein said atmosphere component includes one or more enhancements designed to create an alternate reality for said participant;
a personal accoutrements component, wherein said person accoutrements component includes at least an arrangement for enabling said participant to become a persona that is an integrated member of said alternate reality; and
an activity component, wherein said activity component includes a plurality of events that support a unified entertainment theme that further enhances said participant's experience in said alternate reality.

2. The arrangement of claim 1 wherein said immersive experience for said participant occurs offline at an entertainment center.

3. The arrangement of claim 2 wherein said immersive experience for said participant occurs online in a web-based environment.

4. The arrangement of claim 3 wherein said immersive experience for said participant occurs when said participant is at least at one of said entertainment center and in said web-based environment.

5. The arrangement of claim 1 wherein said immersive experience includes an offline component, wherein said offline component includes
an offline alternative reality module, wherein said offline alternative reality module is configured for at least creating said alternate reality when said participant enter an entertainment center,
an offline activity module, wherein said offline activity module is configured for at least providing one of said plurality of events in enhancing said participant's experience in said alternate reality at said entertainment center,
an offline security module, wherein said offline security module is configured for at least providing a secured environment for said entertainment center, and
an offline administrative module, wherein said offline administrative module is configured for at least handling administration relating to said entertainment center.

6. The arrangement of claim 5 wherein said immersive experience includes an online component, wherein said online component includes
an online alternative reality module, wherein said online alternative reality module is configured for at least creating said alternate reality for said participant in a web-based environment,
an online activity module, wherein said online activity module is configured for at least providing one of said plurality of events in enhancing said participant's experience in said alternate reality at said web-based environment,
an online security module, wherein said online security module is configured for at least providing a secured environment online for said participant, and
an online administrative module, wherein said online administrative module is configured for at least handling administration relating to said web-based environment.

7. The arrangement of claim 6 wherein said secured environment includes an invitation-only online community, wherein said invitation-only online community includes only participants invited to join said invitation-only online community.

8. The arrangement of claim 7 wherein said immersive experience for said participant occurs by participating in said plurality of events, said plurality of events including at least one of online activities that simulate activities performed at said entertainment center, activities at said entertainment center that are designed using online activities, and virtual activities that are available online regardless if said virtual activities are played at said entertainment center or at a location away from said entertainment center.

9. The arrangement of claim 8 wherein scores attained by said participants by participating in said plurality of events are redeemable for prizes, wherein said prizes include at least online prizes and offline prizes.

10. A method for creating an immersive experience for a participant, comprising:
providing an atmosphere using one or more enhancements, wherein said enhancements are configured for at least creating an alternate reality for said participant;
providing an arrangement for said participant to create a persona for participating in said alternate reality; and
supplying a set of activities, wherein said set of activities is designed to support a unified entertainment theme created by said alternate reality.

11. The method of claim 10 wherein said immersive experience for said participant occurs offline at an entertainment center.

12. The method of claim 11 wherein said immersive experience for said participant occurs online in a web-based environment.

13. The method of claim 12 wherein said immersive experience for said participant occurs when said participant is at least at one of said entertainment center and in said web-based environment.

14. The method of claim 13 wherein said participant participates in said alternate reality by establishing membership, wherein said membership includes at least one of paid membership and unpaid membership.

15. The method of claim 14 wherein said membership enables said participant to participate at least at one of said entertainment center and in said web-based environment.

16. The method of claim 15 wherein said immersive experience is provided in a secured environment.

17. The method of claim 16 wherein said secured environment includes an invitation-only online community, wherein said invitation-only online community includes only participants invited to join said invitation-only online community.

18. The method of claim 17 wherein said immersive experience for said participant occurs by participating in said set of activities, said set of activities including at least one of online activities that simulate activities performed at said entertainment center, activities at said entertainment center that are designed using online activities, and virtual activities that are available online regardless if said virtual activities are played at said entertainment center or at a location away from said entertainment center.

19. The method of claim 18 wherein scores attained by said participants by participating in said set of activities are redeemable for prizes, wherein said prizes include at least online prizes and offline prizes.

20. The method of claim 19 further including providing guidance for enabling a special event to be setup, wherein said providing guidance is configured to include at least one of providing staff members to assist an arranger in setting up said special event, providing written instructions for setting up said special event, and providing online assistance for guiding said arranger through steps for setting up said special event.
